(19) United States
(12) Patent Application Publication
(10) Pub. No.: US 2026/0097666 A1
(43) Pub. Date: Apr. 9, 2026

(54) VEHICLE BATTERY MOUNTING STRUCTURE

(71) Applicants: Hyundai Motor Company, Seoul (KR); Kia Corporation, Seoul (KR)

(72) Inventors: Min Sik BANG, Hwaseong-Si (KR); Jae Hyeon JU, Hwaseong-Si (KR); Kyu Bin CHUNG, Hwaseong-Si (KR); Hwan NOH, Hwaseong-Si (KR); Hyun Wook JOON, Hwaseong-Si (KR); Hyeon Su JIN, Hwaseong-Si (KR); Min Je JO, Hwaseong-Si (KR)

(73) Assignees: Hyundai Motor Company, Seoul (KR); Kia Corporation, Seoul (KR)

(21) Appl. No.: 19/195,159

(22) Filed: Apr. 30, 2025

(30) Foreign Application Priority Data
Oct. 8, 2024 (KR) 10-2024-0136757

(51) Int. Cl. B60L 50/64; H01M 50/204; H01M 50/242; H01M 50/249; H01M 50/262

(52) U.S. Cl. CPC B60L 50/64; H01M 50/204; H01M 50/242; H01M 50/249; H01M 50/262; H01M 2220/20

(57) ABSTRACT

A vehicle battery mounting structure includes a cell assembly including a plurality of battery cells overlapping one another, a mounting flange protruding from the cell assembly, a fastening member configured to fix the mounting flange, and a mounting portion formed at an end portion of the mounting flange and surrounding a portion of a periphery of the fastening member.

### CROSS-REFERENCE TO RELATED APPLICATION

The present application claims priority to Korean Patent Application No. 10-2024-0136757, filed on Oct. 8, 2024, the entire contents of which is incorporated herein for all purposes by this reference.

### BACKGROUND OF THE PRESENT DISCLOSURE

### Field of the Present Disclosure

The present disclosure relates to a technology related to a structure for mounting a battery in an electric vehicle or the like.

### Description of Related Art

A battery is mounted in a hybrid vehicle, an electric vehicle, and the like to supply electric power required to operate the vehicles.

In general, the battery is mounted in a form of a battery pack in the vehicles. A plurality of battery modules is accommodated in the battery pack, and each battery module includes a plurality of battery cells.

The battery pack includes components such as a battery casing, the plurality of battery modules accommodated in the battery casing, a battery management assembly (BMA), and a power relay assembly (PRA).

The battery casing may include a first casing configured to define an accommodation space for accommodating the battery module therein, and an upper cover coupled to an upper side of the first casing and configured to seal the accommodation space. The battery casing may include a plurality of internal members configured to traverse the inside of the battery casing, ensuring rigidity of the battery casing and effectively protecting the accommodated battery module.

It is advantageous to increase the number of internal members to be provided in the battery casing to ensure sufficient rigidity of the battery casing and the battery pack. However, to improve a constant speed distance of the electric vehicle or the like, there is a tendency toward reducing the number or volumes of components, such as the internal members, to increase the number of battery modules or battery cells accommodated in the battery casing.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle battery mounting structure which may ensure a collision buffer space of a battery pack and increase an energy density by reducing a width of an internal member of the battery pack, and improve assembling workability of the battery pack by reducing the number of fastening elements configured to fix a cell assembly to a battery casing.

Technical problems to be solved by the present disclosure are not limited to the above-mentioned technical problems, and other technical problems, which are not mentioned above, may be clearly understood from the following descriptions by those skilled in the art to which the present disclosure pertains.

To achieve the above-mentioned object, the present disclosure provides a vehicle battery mounting structure including: a cell assembly including a plurality of battery cells overlapping one another; a mounting flange protruding from the cell assembly; a fastening member fixing the mounting flange; and a mounting portion formed at an end portion of the mounting flange and surrounding a portion of a periphery of the fastening member.

The mounting portion of the mounting flange may be formed in a shape that surrounds half or less the periphery of the fastening member.

The mounting flanges may symmetrically protrude from two opposite sides of the cell assemblies, and the mounting portions of the two mounting flanges, which are disposed to face each other and protrude from the two cell assemblies disposed adjacent to each other, may be provided as arc-shaped grooves that surround a portion of the periphery of the fastening member, respectively.

The plurality of cell assemblies may be accommodated in a first casing, the first casing may include a plurality of internal members dividing accommodation spaces for the cell assemblies, the mounting flange of any one of the cell assemblies, which overlaps the internal member, may be aligned to the mounting flange of another adjacent cell assembly, and the two mounting flanges, which face each other, may be fixed to the internal member by the fastening member connected to the internal member through a portion between the mounting portions of the two mounting flanges.

The internal member may include a guide bushing surrounded by the mounting portions of the two mounting flanges facing each other, and the fastening member may be inserted into the guide bushing.

The vehicle battery mounting structure may further include: a coupling bracket configured to surround the two mounting flanges, which face each other, and connected to the internal member with the two mounting flanges interposed therebetween.

A mounting bracket may be provided on the first casing and overlap the mounting flange of the cell assembly, and the mounting flange, which is not aligned with the mounting flange of another adjacent cell assembly among the mounting flanges of the cell assemblies, may be fixed to the mounting bracket by the fastening member.

The mounting bracket may include a guide bushing surrounded by the mounting portion of the mounting flange and configured so that the fastening member is inserted into the guide bushing, and the mounting bracket may include a symmetric portion including a shape formed symmetrically with the mounting portion of the mounting flange with respect to the guide bushing.

The mounting bracket may be fixed to two opposite side wall portions of the first casing that face each other.

The plurality of battery cells of the cell assembly may be configured to overlap one another in a row, and the mounting flanges may be formed to protrude from first and second opposite end portions of at least one mid-plate disposed between the plurality of battery cells that forms the cell assembly.

Furthermore, to achieve the above-mentioned object, the present disclosure provides a cell assembly including: a plurality of battery cells overlapping one another in a row; at least one mid-plate disposed between the plurality of battery cells overlapping one another; mounting flanges respectively protruding from first and second opposite end portions of the mid-plate; and mounting portions provided at end portions of the mounting flanges in a shape that surrounds a portion of a fastening member fixing the mounting flange.

The mounting portion of the mounting flange may be formed in a shape that surrounds half or less the periphery of the fastening member.

The mounting portion of the mounting flange may be formed in a shape formed symmetrically with the mounting portion of the mounting flange of another cell assembly disposed to face the cell assembly with respect to the fastening member.

The mounting portion of the mounting flange may be formed as an arc-shaped groove that surrounds a portion of a periphery of the fastening member.

According to the vehicle battery mounting structure of the present disclosure, it is possible to ensure the collision buffer space of the battery pack and increase the energy density by reducing the width of the internal member of the battery pack, and improve assembling workability of the battery pack by reducing the number of fastening elements configured to fix the cell assembly to the battery casing.

The effects obtained by the present disclosure are not limited to the aforementioned effects, and other effects, which are not mentioned above, will be clearly understood by those skilled in the art from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating an external appearance of a battery pack according to an exemplary embodiment of the present disclosure.

FIG. 2 is a view exemplarily illustrating a state in which a second casing in FIG. 1 is separated upwards.

FIG. 3 is a top plan view of a battery pack from which the second casing in FIG. 2 is removed.

FIG. 4 is a perspective view exemplarily illustrating a cell assembly in FIG. 2.

FIG. 5 is a view for explaining a coupling structure of portion F5 in FIG. 3.

FIG. 6 is a view exemplarily illustrating a state in which mounting flanges of cell assemblies are disposed on an internal member while facing each other from a state in FIG. 5.

FIG. 7 is a cross-sectional view taken along line F7-F7 in FIG. 6.

FIG. 8 is a view exemplarily illustrating another exemplary embodiment of the coupling structure of portion F5 in FIG. 3.

FIG. 9 is a view for explaining a coupling structure of portion F9 in FIG. 3.

FIG. 10 is a view exemplarily illustrating a state in which the mounting flange of the cell assembly is disposed on a mounting bracket from a state in FIG. 9.

FIG. 11 is a cross-sectional view taken along line F11-F11 in FIG. 10.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In the description of the exemplary embodiments included in the present specification, the predetermined descriptions of publicly known related technologies will be omitted when it is determined that the predetermined descriptions may obscure the subject matter of the exemplary embodiments included in the present specification. Furthermore, it should be interpreted that the accompanying drawings are provided only to allow those skilled in the art to easily understand the exemplary embodiments included in the present specification, and the technical spirit included in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

In the present specification, the terms “comprises,” “comprising,” “includes,” “including,” “containing,” “has,” “having” or other variations thereof are inclusive and therefore specify the presence of stated features, integers, steps, operations, elements, components, and/or combinations thereof, but do not preclude the presence or addition of one or more other features, integers, steps, operations, elements, components, and/or combinations thereof.

In any configuration among the configurations included in the present specification, any number of components or various components may be included in the present disclosure included in the present specification. The components may include any combination of the features included in the present specification and be disposed in any configuration among various configurations included in the present specification. The concepts related to the use and operations of the components of the present disclosure, as well as the structure and arrangement of the components of the present disclosure, may be applied not only to various exemplary embodiments discussed in the present specification but also to any number of embodiments in any combination. The exemplary embodiments including various features of various arrangements will be described below with reference to the drawings.

Hereinafter, various embodiments included in the present specification will be described in detail with reference to the accompanying drawings. The same or similar constituent elements are assigned with the same reference numerals regardless of reference numerals, and the repetitive description thereof will be omitted.

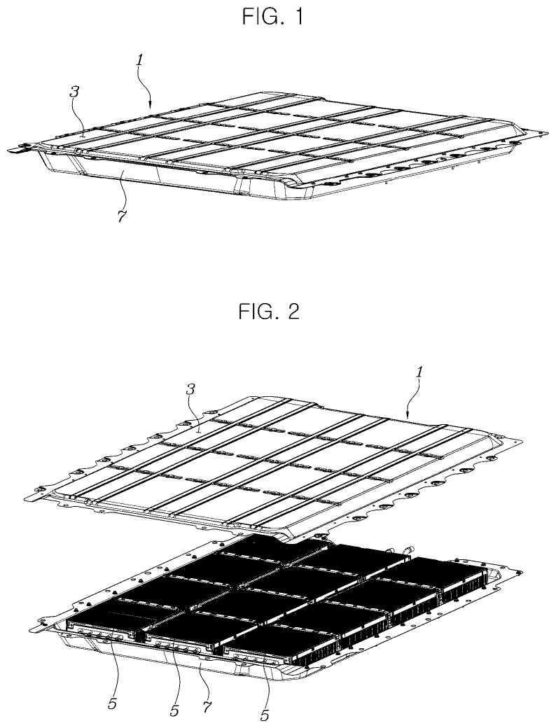

FIG. 1 is a view exemplarily illustrating an external appearance of a battery pack 1 according to an exemplary embodiment of the present disclosure, and FIG. 2 is a view exemplarily illustrating a state in which a second casing 3 in FIG. 1 is separated upwards. In the battery pack 1, a plurality of cell assemblies 5 is accommodated in a space defined by a first casing 7 and the second casing 3.

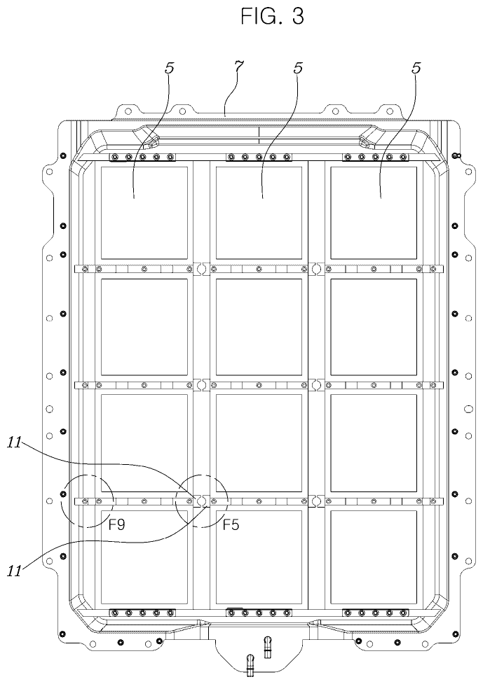

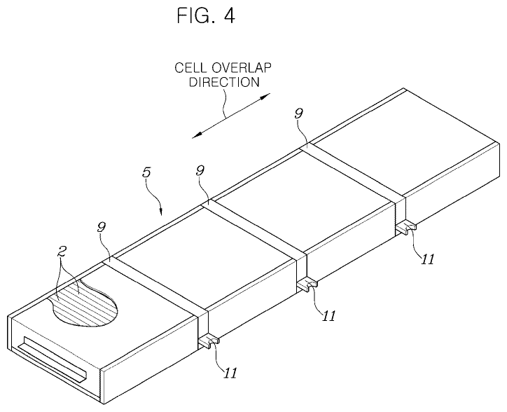

FIG. 3 is a top plan view of the battery pack 1 from which the second casing 3 in FIG. 2 is removed, and FIG. 4 is a view exemplarily illustrating only one cell assembly 5 in FIG. 2.

The cell assembly 5 is formed by a plurality of battery cells 2 overlapping one another straight in a cell overlap direction and each having a plate shape. At least one mid-plate 9 is located between the overlapping battery cells 2.

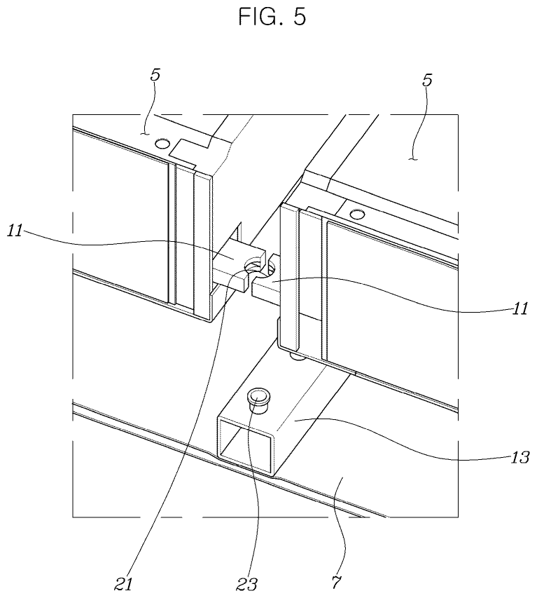

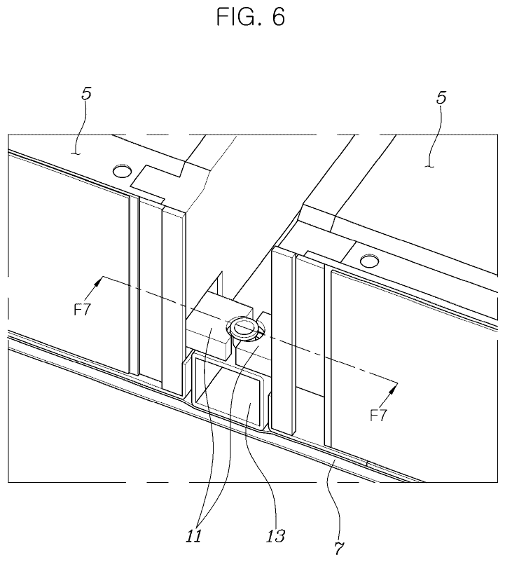

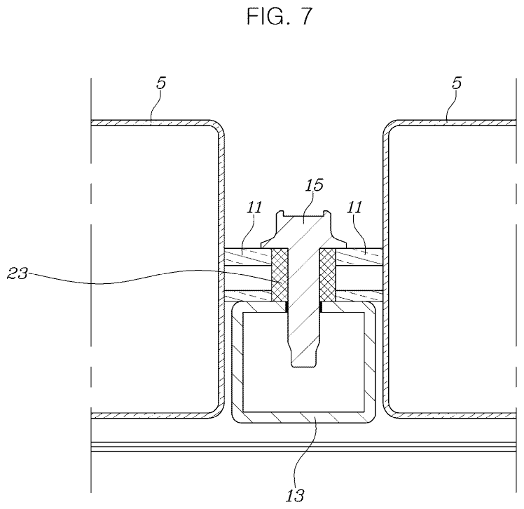

FIG. 5 is a view for explaining a coupling structure of portion F5 in FIG. 3, FIG. 6 is a view exemplarily illustrating a state in which mounting flanges 11 of the cell assemblies 5 are disposed on an internal member 13 while the mounting flanges 11 face each other from a state in FIG. 5, and FIG. 7 is a cross-sectional view taken along line F7-F7 in FIG. 6. After the state is changed from the state in FIG. 5 to the state in FIG. 6, the mounting flanges 11 of the cell assemblies 5 are fixed to the internal member 13 by a fastening member 15, as illustrated in FIG. 7.

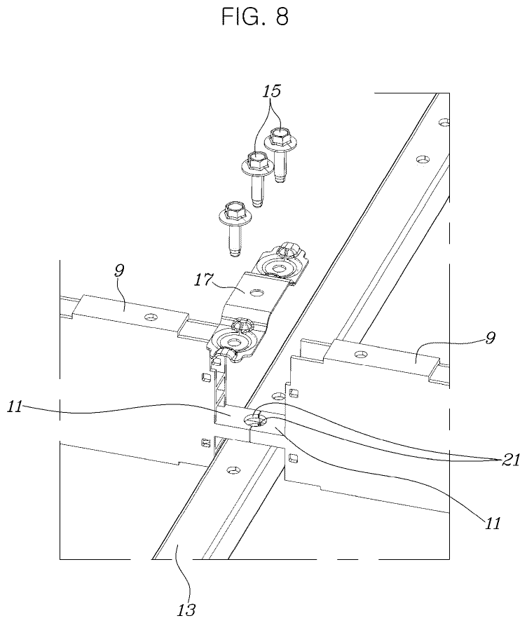

FIG. 8 is a view exemplarily illustrating another exemplary embodiment of the coupling structure of portion F5 in FIG. 3. That is, as illustrated in FIG. 7, portion F5 may include a configuration in which the fastening member 15 is directly coupled between the two mounting flanges 11 facing each other.

Alternatively, as illustrated in FIG. 8, portion F5 may include a configuration in which the fastening member 15 is coupled in a state in which the two mounting flanges 11 facing each other are surrounded by a coupling bracket 17.

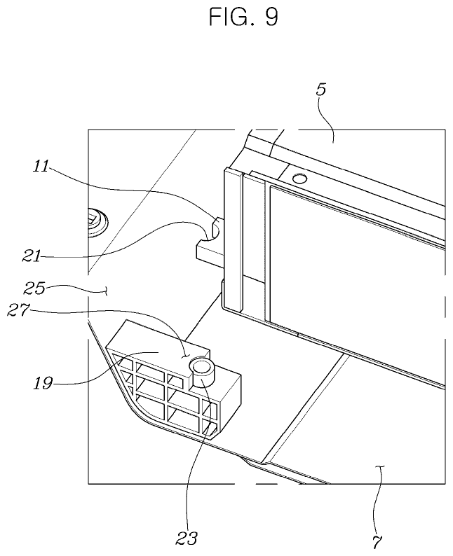

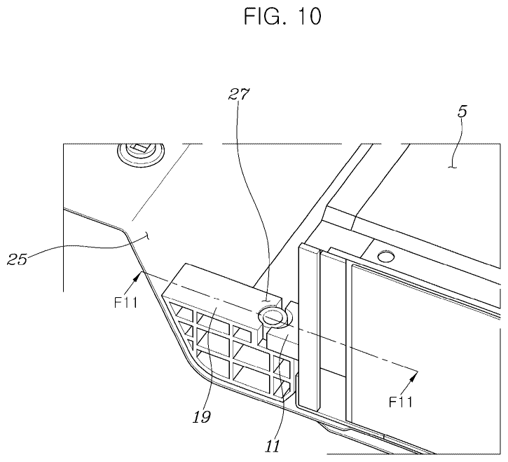

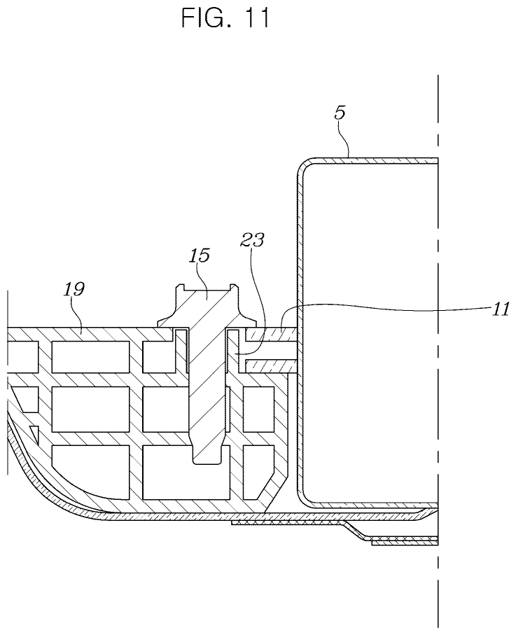

FIG. 9 is a view exemplarily illustrating a coupling structure of portion F9 in FIG. 3, FIG. 10 is a view exemplarily illustrating a state in which the mounting flange 11 of the cell assembly 5 is disposed on a mounting bracket 19 from a state in FIG. 9, and FIG. 11 is a cross-sectional view taken along line F11-F11 in FIG. 10. After the state is changed from the state in FIG. 9 to the state in FIG. 10, the mounting flange 11 of the cell assembly 5 is fixed to the mounting bracket 19 by the fastening member 15, as illustrated in FIG. 11.

With reference to FIGS. 1 to 11, an exemplary embodiment of the vehicle battery mounting structure of the present disclosure includes the cell assembly 5 configured by the plurality of battery cells 2 overlapping one another, the mounting flange 11 protruding from the cell assembly 5, the fastening member 15 configured to fix the mounting flange 11, and a mounting portion 21 provided at an end portion of the mounting flange 11 and formed in a shape that surrounds a portion of a periphery of the fastening member 15.

The mounting portion 21 of the mounting flange 11 is formed in a shape that surrounds half or less the periphery of the fastening member 15. For instance, an end of the mounting flange 11 may be recessed to form an arc-shaped groove.

That is, the mounting flanges 11 symmetrically protrude from two opposite sides of the cell assemblies 5 to form the arc-shaped groove. The mounting portions 21 of the two mounting flanges 11, which protrude from the two adjacent cell assemblies 5 and are disposed to face each other, define arc-shaped grooves that surround a portion of the periphery of the fastening member 15.

Therefore, the mounting portion 21 of each of the mounting flanges 11 may include a structure in which an arc-shaped groove with a shape close to a semi-circular shape is formed at an end portion thereof.

The plurality of cell assemblies 5 is accommodated in the first casing 7, and the plurality of internal members 13 is provided in the first casing 7 and divides the accommodation spaces for the cell assemblies 5. The mounting flange 11 of any one of the cell assemblies 5, which overlaps the internal member 13, is aligned to face the mounting flange 11 of another adjacent cell assembly 5. The two mounting flanges 11 facing each other are fixed to the internal member 13 by the fastening member 15 connected to the internal member 13 through a portion between the mounting portions 21 of the two mounting flanges 11.

Therefore, the two mounting flanges 11, which protrude from the two adjacent cell assemblies 5 while facing each other, may be fixed to the internal member 13 by one fastening member 15 in a state in which the two mounting flanges 11 overlap the internal member 13.

In an exemplary embodiment of the present disclosure, the internal member 13 may include a hole and the fastening member 15 may include a threaded portion such as a screw so that the fastening member 15 may be connected to the hole of the internal member 13.

Therefore, no portion is required to fix the two mounting flanges 11, which protrude while facing each other, to the internal member 13 so that a width of the internal member 13 may be reduced. The present configuration may not only assist in mounting a larger number of battery cells 2 in the battery pack 1 with the same volume to increase a constant speed distance of the vehicle, but also contribute to improving collision performance of the battery pack 1 by advantageously ensuring a space configured for absorbing an impact when the impact is inputted to the battery pack 1 from the outside thereof.

Furthermore, because the two mounting flanges 11, which protrude while facing each other, may be fixed by the single fastening member 15 as described above, it is possible to reduce the necessary number of fastening members of the battery pack 1 and improve the assembling workability of the battery pack 1.

The internal member 13 may include a guide bushing 23 configured to be surrounded by the mounting portions 21 of the two mounting flanges 11 facing each other, and the fastening member 15 may be inserted into the guide bushing 23.

The guide bushing 23 is configured as a guide which may easily ensure an accurate seating position when the mounting flange 11 of the cell assembly 5 is accommodated on the internal member 13 from the state in FIG. 5 to the state in FIG. 6.

FIG. 3 is a view exemplarily illustrating another exemplary embodiment of the coupling structure of portion F5. Another exemplary embodiment of the coupling structure further includes the coupling bracket 17 configured to surround the two mounting flanges 11, which face each other, and connected to the internal member 13 with the two mounting flanges 11 interposed therebetween as shown in FIG. 8.

That is, the two mounting flanges 11, together with the coupling bracket 17, are fixed to the internal member 13 by use of the fastening members 15 in a state in which the two mounting flanges 11, which face each other and protrude from the two cell assemblies 5 disposed adjacent to each other with one internal member 13 interposed therebetween, are aligned on the internal member 13 and the two mounting flanges 11 are surrounded by the coupling bracket 17.

In an exemplary embodiment of the present disclosure, the coupling bracket 17 may include a hole and the two mounting flanges 11 are fixed to the internal member 13 by use of the fastening member 15 through the hole of the coupling bracket 17.

The above-mentioned fixing structure enables the mounting flanges 11 to be fixed in a more secure and stable state while allowing a coupling surface of the coupling bracket 17, which is formed to surround the two mounting flanges 11, to be formed to be large in comparison with the exemplary embodiment in which the fastening member 15 is directly connected between the two mounting flanges 11.

Meanwhile, the first casing 7 includes the mounting bracket 19 that overlaps the mounting flange 11 of the cell assembly 5. Among the mounting flanges 11 of the cell assemblies 5, the mounting flange 11, which is not aligned with the mounting flange 11 of another adjacent cell assembly 5, is fixed to the mounting bracket 19 by the fastening member 15.

In an exemplary embodiment of the present disclosure, the mounting bracket 19 is configured to be fixed to two opposite side wall portions 25 of the first casing 7 that face each other.

That is, as illustrated in FIGS. 9 to 11, the mounting flange 11 may be fixed to the mounting bracket 19 at a location at which only the single mounting flange 11 needs to be fixed, as in portion F9 in FIG. 3.

In an exemplary embodiment of the present disclosure, the mounting bracket 19 includes the guide bushing 23 surrounded by the mounting portion 21 of the mounting flange 11 and configured so that the fastening member 15 is inserted into the guide bushing 23. The mounting bracket 19 includes a symmetric portion 27 configured to define a symmetric shape together with the mounting portion 21 of the mounting flange 11 with respect to the guide bushing 23.

Therefore, when the cell assembly 5 is accommodated on the first casing 7, the mounting flange 11 of the cell assembly 5 may be easily and accurately accommodated on the mounting bracket 19 by the guide bushing 23 of the mounting bracket 19, and the fastening member 15 is connected to press the mounting flange 11 and the symmetric portion 27 of the mounting bracket 19 in a stable state in a balanced manner.

For reference, the mounting flange 11 is configured to integrally protrude from first and second opposite end portions of at least one mid-plate 9 disposed between the plurality of battery cells 2 that forms the cell assembly 5.

The cell assembly 5 of the present disclosure, which may form the vehicle battery mounting structure of the present disclosure described above, includes the plurality of battery cells 2 configured to overlap one another in a row, at least one mid-plate 9 disposed between the plurality of battery cells 2 overlapping one another, the mounting flanges 11 respectively protruding from first and second opposite end portions of the mid-plate 9, and the mounting portions 21 formed at the end portions of the mounting flanges 11 and each including a shape that surrounds a portion of the fastening member 15 configured to fix the mounting flanges 11.

The mounting portion 21 of the mounting flange 11 may be formed in a shape that surrounds half or less the periphery of the fastening member 15.

The mounting portion 21 of the mounting flange 11 may be formed symmetrically with the mounting portion 21 of the mounting flange 11 of another cell assembly 5 disposed to face the cell assembly 5 with respect to the fastening member 15.

The mounting portion 21 of the mounting flange 11 may be formed as an arc-shaped groove that surrounds a portion of the periphery of the fastening member 15.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the exemplary embodiments are used for describing predetermined embodiments, and are not intended to limit the embodiments. As used in the description of the exemplary embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a predetermined condition is satisfied, to perform the related operation or interpret the related definition according to the predetermined condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle battery mounting structure comprising:
a cell assembly including a plurality of battery cells overlapping one another;
a mounting flange protruding from the cell assembly;
a first fastening member fixing the mounting flange; and
a mounting portion formed at an end portion of the mounting flange and surrounding a portion of a periphery of the first fastening member.

2. The vehicle battery mounting structure of claim 1, wherein the mounting portion of the mounting flange is formed to surround half or less the periphery of the first fastening member.

3. The vehicle battery mounting structure of claim 2,
wherein the mounting flange is in plural and the cell assembly is in plural,
wherein the mounting flanges symmetrically protrude from first and second opposite sides of the cell assemblies, and
wherein the mounting portions of the mounting flanges, which are disposed to face each other and protrude from the cell assemblies disposed adjacent to each other, include arc-shaped grooves that surround a portion of the periphery of the first fastening member, respectively.

4. The vehicle battery mounting structure of claim 3, further including a first casing,
wherein the plurality of cell assemblies is accommodated in the first casing,
wherein the first casing includes a plurality of internal members dividing accommodation spaces for the cell assemblies,
wherein the mounting flange of any one of the cell assemblies, which overlaps a corresponding internal member among the plurality of internal members, is aligned to the mounting flange of another adjacent cell assembly, and
wherein the mounting flanges, which face each other, are fixed to the corresponding internal member by the first fastening member connected to the corresponding internal member through a portion between the mounting portions of the mounting flanges.

5. The vehicle battery mounting structure of claim 4, wherein the corresponding internal member includes a guide bushing surrounded by the mounting portions of the mounting flanges facing each other, and the first fastening member is inserted into the guide bushing.

6. The vehicle battery mounting structure of claim 4, further including:
a coupling bracket surrounding the mounting flanges, which face each other, and connected to the corresponding internal member by at least a second fastening member with the mounting flanges interposed therebetween.

7. The vehicle battery mounting structure of claim 4, further including a mounting bracket,
wherein the mounting bracket is provided on the first casing and overlaps the mounting flanges of the cell assemblies, and
wherein the mounting flange, which is not aligned with the mounting flange of another adjacent cell assembly among the mounting flanges of the cell assemblies, is fixed to the mounting bracket by the first fastening member.

8. The vehicle battery mounting structure of claim 7,
wherein the mounting bracket includes a guide bushing surrounded by the mounting portion of the mounting flanges and configured so that the first fastening member is inserted into the guide bushing.

9. The vehicle battery mounting structure of claim 8,
wherein the mounting bracket includes a symmetric portion formed symmetrically with the mounting portion of the mounting flanges with respect to the guide bushing.

10. The vehicle battery mounting structure of claim 7, wherein the mounting bracket is fixed to two opposite side wall portions of the first casing that face each other.

11. The vehicle battery mounting structure of claim 9, further including at least one mid-plate disposed between the plurality of battery cells that forms the cell assembly,
wherein the mounting flanges are formed to protrude from first and second opposite end portions of the at least one mid-plate disposed between the plurality of battery cells and engaged to the symmetric portion of the mounting bracket.

12. The vehicle battery mounting structure of claim 11, wherein a coupling bracket is connected to the internal member to press the mounting flanges and the symmetric portion of the mounting bracket.

13. The vehicle battery mounting structure of claim 1, further including at least one mid-plate disposed between the plurality of battery cells that forms the cell assembly
wherein the plurality of battery cells of the cell assembly overlaps one another in a row, and
wherein the mounting flange is formed to protrude from first and second opposite end portions of the at least one mid-plate disposed between the plurality of battery cells that forms the cell assembly.

14. A cell assembly including:
a plurality of battery cells overlapping one another in a row;
at least one mid-plate disposed between the plurality of battery cells overlapping one another;
mounting flanges respectively protruding from first and second opposite end portions of the at least one mid-plate; and
mounting portions formed at end portions of the mounting flanges and surrounding a portion of a fastening member fixing the mounting flanges.

15. The cell assembly of claim 14, wherein the mounting portions of the mounting flanges are formed to surround half or less a periphery of the fastening member.

16. The cell assembly of claim 15, wherein the mounting portion of the mounting flange is formed symmetrically with a mounting portion of a mounting flange of another cell assembly disposed to face the cell assembly with respect to the fastening member.

17. The cell assembly of claim 16, wherein the mounting portion of the mounting flange includes an arc-shaped groove that surrounds a portion of the periphery of the fastening member.
